(19) United States
(12) Patent Application Publication
(10) Pub. No.: US 2011/0087871 A1
(43) Pub. Date: Apr. 14, 2011

(54) CONSUMER ELECTRONIC DEVICE AND METHOD OF CONTROLLING A CONSUMER ELECTRONIC DEVICE

(75) Inventors: O-kyun KWON, Seoul (KR); Se-an KWON, Yongin-si (KR); Seong-min KANG, Hwaseong-si (KR); Jae-seuk OH, Seoul (KR)

(73) Assignee: SAMSUNG ELECTRONICS CO., LTD., Suwon-si (KR)

(21) Appl. No.: 12/783,263

(22) Filed: May 19, 2010

(30) Foreign Application Priority Data
Oct. 9, 2009 (KR) 10-2009-0096401

(51) Int. Cl. G06F 9/24; G06F 1/32

(52) U.S. Cl. 713/2; 713/323

(57) ABSTRACT

A method and apparatus for controlling a consumer electronics (CE) device, are provided. The method includes determining, when a touch is sensed, whether the touch corresponds to a booting request, and performing a booting operation when the touch is a booting request; and controlling the CE device to operate in a sleep mode when an operation start signal is not received until the booting operation is completed, and controlling the CE device to operate in a normal mode when an operation start signal is received before the booting operation is completed. The apparatus includes a touch sensing unit; which senses a touch to the CE device; a determining unit which determines whether the touch sensed by the touch sensing unit corresponds to a booting request; a booting unit, and a control unit controlling the CE device.

### CROSS-REFERENCE TO RELATED PATENT APPLICATION

This application claims priority from Korean Patent Application No. 10-2009-0096401, filed on Oct. 9, 2009, in the Korean Intellectual Property Office, the disclosure of which is incorporated herein in its entirety by reference.

### BACKGROUND

1. Field

The exemplary embodiments relate to a consumer electronics (CE) device and a method of controlling the CE device, and more particularly, to a CE device in which a booting operation can be quickly performed, as well as a method of controlling the CE device.

2. Description of the Related Art

CE devices having various functions are becoming increasingly popular due to the development of information communication technology. In particular, image photographing apparatuses have significantly developed as user demand for storing photographs of beautiful objects or scenes has increased.

When photographing a subject using an image photographing apparatus, it is important to photograph a subject at a desired point of time.

### SUMMARY

The exemplary embodiments provide a consumer electronics (CE) device in which a booting operation can be quickly performed, as well as a method of controlling the CE device.

According to an aspect of the exemplary embodiments, there is provided a method of controlling aCE device, which includes sensing a touch to the CE device; determining whether the touch corresponds to a booting request; performing a booting operation when the touch is a booting request; and controlling the CE device to operate in the sleep mode when an operation start signal is not received until the booting operation is completed.

The performing of the booting operation may include performing a booting operation according to a first booting mode in which data is not output to outside of the CE device during the booting operation.

The performing of the booting operation may further include performing a booting operation according to a second booting mode in which data processed during the booting operation is output to outside of the CE device when the operation start signal is received before the booting operation, according to the first booting mode being received.

The determining may include determining whether the touch corresponds to a booting request, based on position information of a portion of the CE device where the touch is sensed.

The method may further include setting a condition that the touch is determined as a booting request, based on touch position history information, about a touch sensed at a previous point of time.

The controlling may include a resuming operation such that the CE device operates in a normal mode when an operation start signal is received while the CE device operates in a sleep mode.

The controlling may include controlling a power supply to at least one module included in the CE device, according to an operational mode of the CE device.

The controlling of the power supply may include blocking the power supply to modules, except for a control module which is to perform a resuming operation and a memory in which non-volatile data is stored, while the CE device operates in the sleep mode.

The controlling the CE device may include controlling the CE device to operate in the end mode when the sleep mode continues for a predetermined length of time or longer.

According to another aspect of the exemplary embodiments, there is provided a consumer electronics (CE) device including a touch sensing unit sensing a touch to the CE device; a determining unit which determines whether the touch sensed by the touch sensing unit corresponds to a booting request; a booting unit which performs a booting operation if the touch is a booting request; and a control unit which controls the CE device to operate in a sleep mode when an operation start signal is not received until the booting operation is completed.

### BRIEF DESCRIPTION OF THE DRAWINGS

The above and other features and advantages of the exemplary embodiments will become more apparent by describing in detail exemplary embodiments thereof with reference to the attached drawings in which:

FIG. 1 is a block diagram illustrating a consumer electronics (CE) device according to an exemplary embodiment;

FIG. 2 illustrates an example of data about touch history according an exemplary embodiment;

FIG. 3 illustrates an example of using a CE device according to an exemplary embodiment;

FIGS. 4A through 4C are flowcharts illustrating a booting method according to a booting mode, in accordance with an exemplary embodiment;

FIG. 5 illustrates an example of conversion of an operational mode of a CE device, according to an exemplary embodiment;

FIG. 6 illustrates an operational state of a module in an operational mode of a CE device, according to an exemplary embodiment;

FIGS. 7A through 7D illustrate an operation of a CE device according to time, in accordance with an exemplary embodiment; and

FIG. 8 is a flowchart illustrating a method of controlling a CE device, according to an exemplary embodiment.

### DETAILED DESCRIPTION

The exemplary embodiments will now be described more fully with reference to the accompanying drawings, which illustrate the exemplary embodiments.

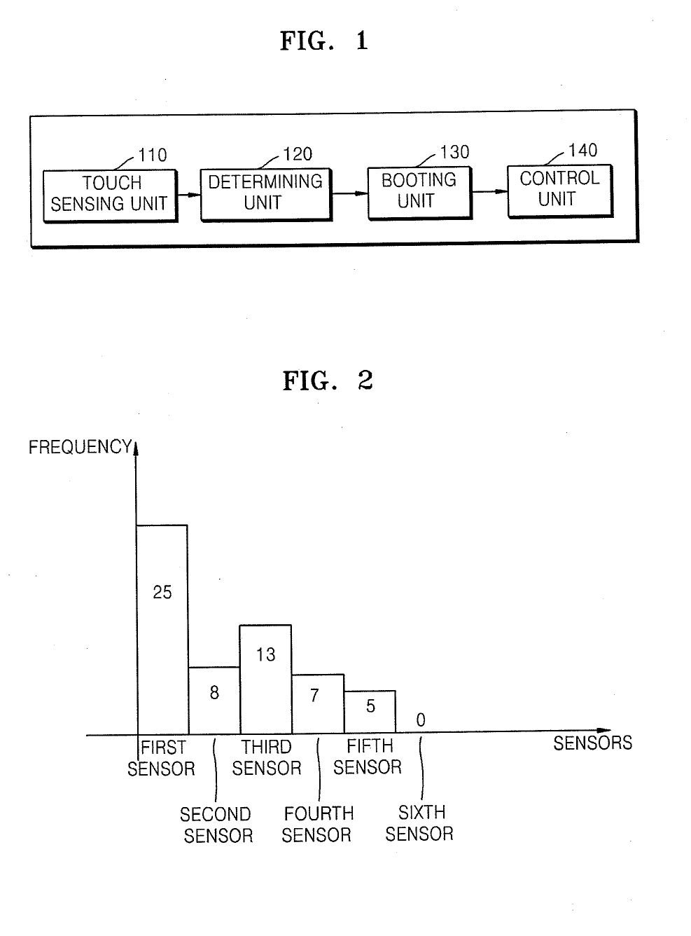

FIG. 1 is a block diagram illustrating a consumer electronics(CE) device according to an exemplary embodiment. The CE device includes a touch sensing unit 110, a determining unit 120, a booting unit 130, and a control unit 140.

The touch sensing unit 110 senses whether the CE device is touched. The touch sensing unit 110 may include at least one sensor that is capable of sensing a touch, such as an electrostatic capacitive touch sensor, a decompression touch sensor, or a vibration sensor. Hereinafter, it is assumed that the touch sensing unit 110 includes an electrostatic capacitive touch sensor, for ease of description.

The electrostatic capacitive touch sensor senses a touch based on an amount of charges that are moved. Accordingly, if the touch sensing unit 110 includes an electrostatic capacitive touch sensor, a touch may be determined even when a user's finger or a touch pen does not directly touch the electrostatic capacitive touch sensor. The touch sensing unit 110 adjusts sensitivity by determining a critical value of the amount of movement of the charges, which is to be determined as a touch.

In particular, when the touch sensing unit 110 includes a plurality of touch sensors, critical values may be set differently for the touch sensors. For example, a touch sensor may be set for a high critical value when disposed in a portion which is highly likely to be touched by mistake by the user, and a low critical value may be set for a touch sensor disposed at a portion of the CE device which is less likely to be mistakenly touched by the user.

Touch sensing unit 110 performs an operation, via the touch sensor, such as filtering with respect to a signal output, to thereby eliminate noise, and may determine whether a touch has occurred, based on the signal from which noise has been eliminated.

Determining unit 120 detects the intention of the user based on information about a touch, such as a position where the touch is sensed, a time the touch is sensed, and a time period that the touch was maintained. Determining unit 120 may determine whether the sensed touch corresponds to a booting request. The user may touch the CE device in order to use the CE device but may also touch the CE device by mistake, or may move the CE device without intending to use the CE device. Accordingly, determining unit 120 determines a touch that satisfies only a predetermined condition as corresponding to a booting request.

Conditions for determining whether or not a sensed touch is a booting request may be variously set according to the exemplary embodiments. For example, determining unit 120 may set a condition based on history information regarding a touch position. The touch position history information includes position information regarding a portion of the CE device frequently touched by the user when using the CE device. When the user uses the CE device, there is a particular portion of the CE device that is frequently touched by the user's fingers. Accordingly, when a touch of the particular portion is sensed, it is regarded as the user trying to use the CE device. An example of the touch position details will be described later with reference to FIG. 2.

Determining unit 120 may set a condition such that a booting operation is regarded as received if a touch is sensed in one predetermined portion, or in at least two portions at the same time, or sequentially in at least two portions. In the case when a touch is sensed in at least two portions, the touch sensing unit 110 needs to include a plurality of touch sensors.

In addition, when the user's thumb touches a predetermined portion of the CE device, the condition that the touch is determined as a booting request may be set in consideration of both a type of touch and a position of the touch, or in consideration of both the time and position of the touch.

Booting unit 130 performs a booting operation according to a booting mode, when a touch is determined to be a booting request. In the present specification, a booting mode will be classified as two modes. A booting mode in which all operations needed to normally operate a CE device are performed will be referred to as a second booting mode. A booting mode in which some of the booting operations of the second booting mode are performed, will be referred to as a first booting mode. During booting operations according to the first booting mode, data may not be output to outside of the CE device. Accordingly, while the booting operations according to the first booting mode are performed, the user may not be aware that the booting operations are being performed. Thus, the first booting mode may also be referred to as an internal booting mode or a background booting mode in that the user may not be aware that the booting operations are being performed.

Operations performed in each booting mode may vary according to the type of CE device and the embodiments of the exemplary embodiments. For example, it is assumed that the CE device is an image reproducing apparatus. In this case, booting operations according to the second booting mode such as running an operating system (OS), initiating an application, channel tuning, decoding data received via the tuned channel and outputting the decoded data, may be performed. Here, according to the first booting mode, only the booting operations such as running an OS and initiating an application may be performed, and channel tuning, data decoding and data outputting may not be performed.

When a touch is sensed to be a booting request, booting unit 130 performs a booting operation according to the first booting mode. If an operation start signal is received before the booting operations according to the first booting mode are ended, booting unit 130 performs a booting operation according to the second booting mode subsequent to the booting operations that have just been processed. The operation start signal refers to a signal that is generated when the user requests to start the CE device to start operating. For example, the operation start signal may be generated by the user pressing a ‘power on’ button mounted on a remote control or the CE device.

Control unit 140 determines an operational mode of the CE device and controls the CE device to operate according to the determined operational mode.

According to an exemplary embodiment, the operational modes of the CE device are classified as an end mode, a sleep mode, and a normal mode.

First, in the end mode, power is not supplied to all or most of modules in the CE device. The end mode may also be referred to the power-off mode. For example, in the end mode, power supply to all modules except a touch sensor may be blocked. Accordingly, when the CE device operates in the end mode, the user may not use the CE device and thus the user requests a booting operation such that the operational mode of the CE device changes from the end mode to the normal mode to thereby use the CE device in a normal manner.

Next, in the sleep mode, some hardware drivers or some modules in the CE device do not operate, or operate at lower power consumption levels. For example, in the sleep mode, power supply to all modules except a non-volatile memory in which data is stored, a module that performs a resuming operation, and an interface module that receives a user input, may be blocked. When the CE device operates in the sleep mode, the user may not use the CE device normally and thus the user requests a resuming operation such that the operational mode of the CE device changes from the sleep mode to the normal mode, to thereby use the CE device in a normal manner.

Finally, in the normal mode, power is supplied to most or all of the modules in the CE device. In the normal mode, the user may use the CE device in a normal manner.

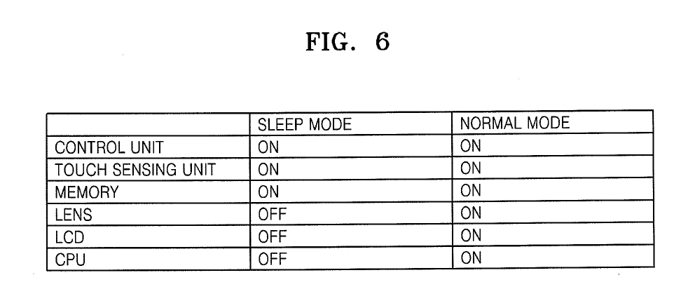

Conversion of the operational mode of the CE device will be described later with reference to FIG. 5, and states of the modules in each of the operational modes will be described later with reference to FIG. 6.

Control unit 140 controls the CE device to operate in the sleep mode if an operation start signal is not received until the booting operations according to the first booting mode are ended. The control unit controls the CE device to operate in the normal mode when booting operations according to the second booting mode are ended. When an operation start signal is received while the CE device is operating in the sleep mode, control unit 140 performs a resuming operation so that the CE device operates in the normal mode. When a touch is not sensed from the user for a critical length of time or longer, while the CE device is operating in the normal mode, control unit 140 controls such that the CE device operates in the sleep mode. In particular, if a touch is not sensed by the user for a critical length of time or longer after the operational mode of the CE device changes from the normal mode to the sleep mode, the CE device may be controlled so as to operate in the end mode.

In general, a long time is required in order for the CE device to be normally booted. Thus, the user cannot immediately use the CE device at a desired time. In particular, when the user uses a camera or a camcorder, desired image data may be obtained by immediately using the CE device at a desired time. However, according to the conventional art, desired image data may not be obtained due to the time required to perform the booting operation.

However, according to an exemplary embodiment, the booting operations according to the first booting mode are performed when touching of the CE device by the user satisfies a predetermined condition, even when an operation start signal has not yet been received. This is based on the concept that it may be necessary for the user to touch the CE device before an operation start signal is received from the user, in the CE device. Accordingly, the user may quickly use the CE device at a desired time.

FIG. 2 illustrates an example of data about touch history according an embodiment of the present invention.

In FIG. 2, a horizontal axis denotes sensors, and a vertical axis denotes that the number of times the user has touched each of the sensors when using the CE device. In FIG. 2, the user has frequently touched the CE device in the order of a first sensor, a third sensor, a second sensor, a fourth sensor, a fifth sensor and a sixth sensor. Thus, when a touch is sensed by the first sensor, it may be determined that there is a high probability that a user is using the CE device. Determining unit 120 determines that a booting request is received when a touch is sensed by the first sensor, when a touch is sensed by the first and third sensors at the same time, or when a touch is sensed by the first sensor and then a touch is sensed in the third sensor.

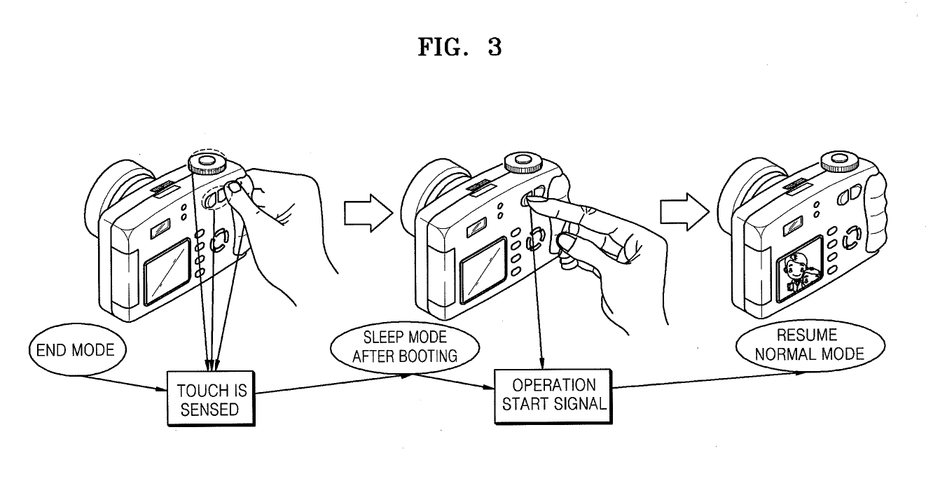

FIG. 3 illustrates an example of using a CE device according to an exemplary embodiment.

In FIG. 3, a camera is used as the CE device. However, the CE device is not limited to a camera. The camera illustrated in FIG. 3 includes three touch sensors.

Initially, an operational mode of the camera is an end mode. Accordingly, power is not supplied to any other module except a touch sensor.

When a touch to the touch sensor is sensed, determining unit 120 determines whether the sensed touch corresponds to a booting request. In FIG. 3, it is assumed that the user's finger has touched a grip, which is regarded as a booting request.

Booting unit 130 performs a booting operation according to a first booting mode. When the user does not press on a ‘power on’ button until booting operations according to the first booting mode are ended, control unit 140 controls such that the camera operates in the sleep mode.

When the user presses the ‘power on’ button while the camera is operating in the sleep mode, control unit 140 performs a resuming operation.

When the resuming operation is ended, control unit 140 controls the camera to operate in the normal mode.

When the camera operates in the normal mode, the user may use the camera in a normal manner, and thus the user may photograph a subject or reproduce the photographed subject by using the camera.

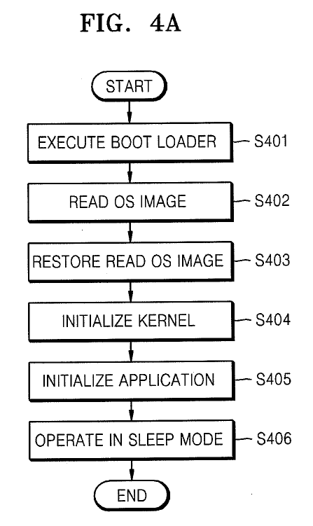

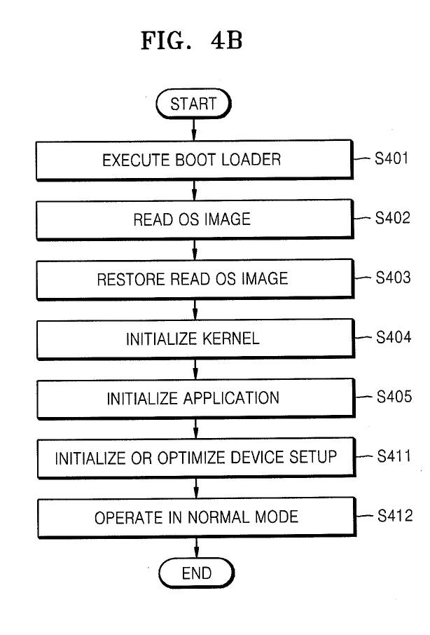

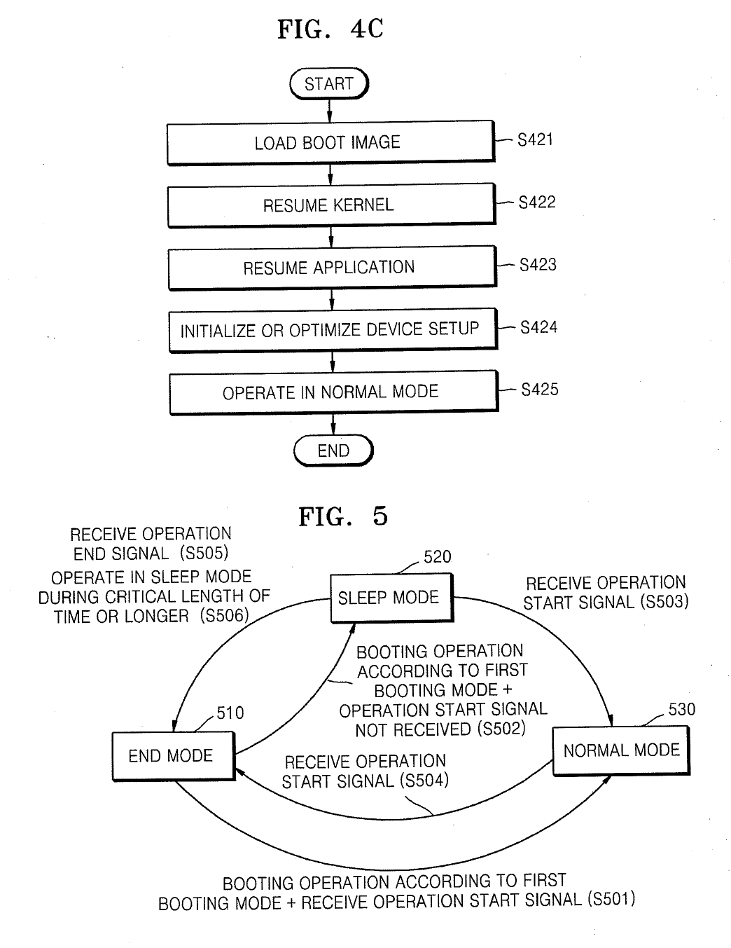

FIGS. 4A through 4C are flowcharts illustrating a booting method according to a first booting mode, in accordance with an exemplary embodiment. In FIG. 4A, a camera is used as an example of a CE device.

In operation S401, a boot loader is executed.

In operation S402, an OS image is read from a memory.

In operation S403, the read OS image is restored. For example, if the read OS image is compressed, the OS image is decompressed. In operations S402 and S403, an OS is loaded.

In S404, a kernel is initialized.

In operation S405, an application is initialized.

In operation S406, the CE device is controlled to operate in the sleep mode. In operation S406, results of operations S401 and S405 are generated as boot images and stored in a memory. In the sleep mode, power may be supplied only to the control unit 140 which is to perform a resuming operation, an interface unit (not shown) which is to receive an operation start signal from the user and the memory in which the boot images are recorded.

FIG. 4B is a flowchart illustrating a booting operation according to a second booting mode, in accordance with an exemplary embodiment.

Operations S401 through S405 are the same as in FIG. 4A and thus a description thereof will be omitted.

In operation S411, setup of the CE device is optimized or initialized. When the CE device is a camera, the setup of the CE device such as an aperture value or a focal distance is optimized or initialized.

In operation S412, operation is controlled such that the CE device operates in a normal mode.

FIG. 4C is a flowchart illustrating a resuming operation, in accordance with an exemplary embodiment.

In operation S421, a boot image is loaded from a memory.

In operation S422, kernel operations are resumed based on the boot image.

In operation S423, an application is resumed based on the boot image.

In operation S424, setup of the CE device is initialized or optimized.

In operation S425, the CE device is controlled to operate in a normal mode.

FIG. 5 illustrates an example of conversion of an operational mode of a CE device in accordance with an exemplary embodiment.

In an end mode 510, when a touch by a user to the CE device is sensed, determining unit 120 determines whether the sensed touch is a booting request. When the user's touch is determined to be a booting request, the CE device is booted according to a first booting mode. When an operation start signal is received before a booting operation according to the first booting mode is completed, booting unit 130 boots the CE device according to a second booting mode subsequent to the booting operation according to the first booting mode, that has been just performed. When the booting operation according to the second booting mode is ended, the CE device operates in a normal mode 530, in operation S501.

In operation S502, when an operation start signal is not received until the booting operation according to the first mode has ended, the CE device operates in a sleep mode 520.

In operation S503, when an operation start signal is received from the user in the sleep mode 520, control unit 140 performs a resuming operation, and when the resuming operation is completed, the CE device operates in the normal mode 530.

In operation S504, when an operation end signal is received from the user in the normal mode 530, the CE device operates in the end mode 510. That is, the CE device is turned off, except for a touch sensor.

In operation S505, when an operation end signal is received in the sleep mode 520 or a touch is not sensed for a critical length of time or longer when in sleep mode (S506), the operational mode of the CE device is changed to the end mode 510.

FIG. 6 illustrates an operational state of a module in an operational mode of a CE device in accordance with an exemplary embodiment.

In an end mode, power is supplied only to the touch sensing unit 110.

In a sleep mode, power is supplied only to control unit 104, the touch sensing unit 110, and a memory. That is, power is supplied only to modules that are related to a resuming operation.

In the normal mode, power is supplied to all modules.

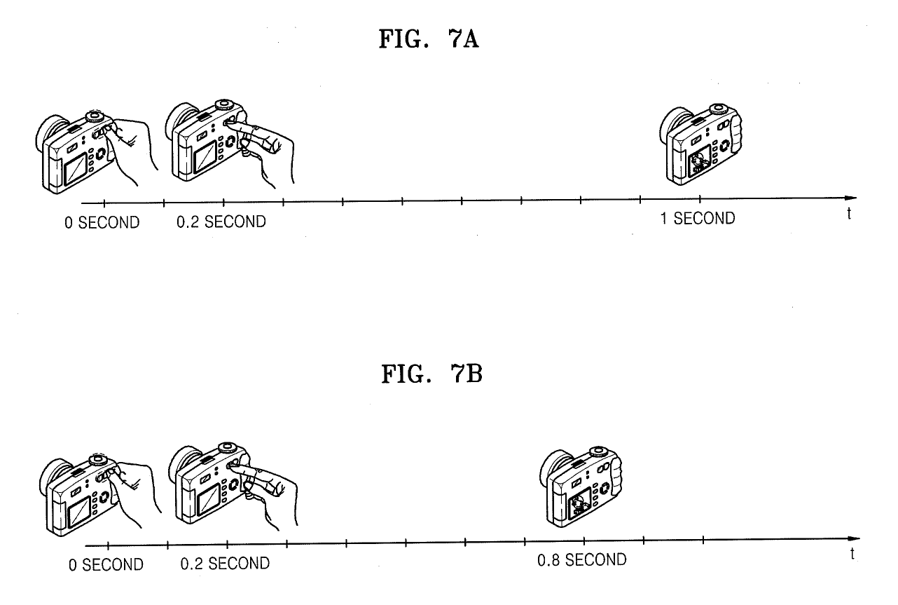

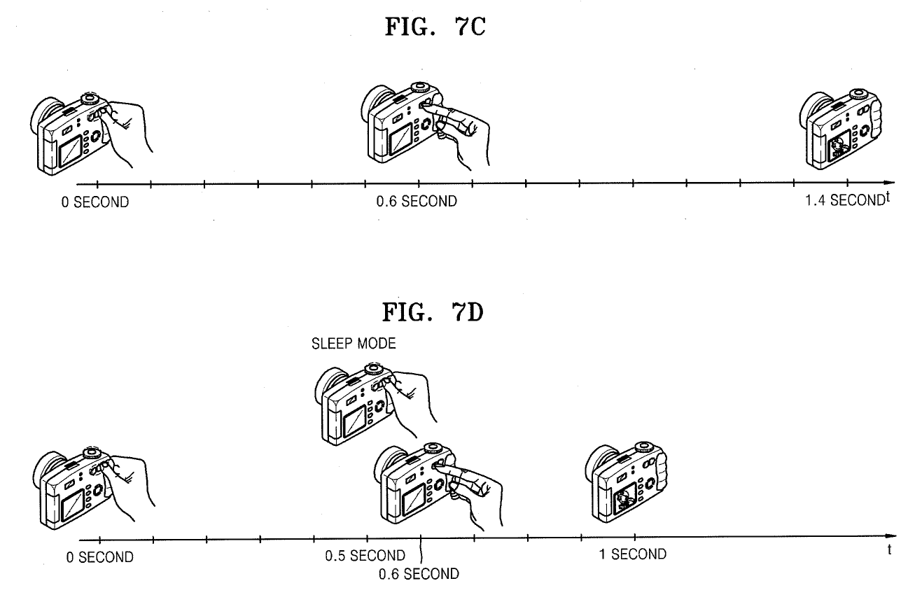

FIGS. 7A through 7D illustrate an operation of a CE device according to time, in accordance with an exemplary embodiment. In FIGS. 7A through 7D, an operation of the CE device is illustrated, with respect to time, indicated as “t” in the Figs. For convenience of description, the time necessary to complete the booting operation according to the first booting mode is 0.5 seconds, the time necessary to complete the booting operation according to the second booting mode is 0.8 seconds, and the time necessary to complete the resuming operation is 0.4 seconds.

An operation of the CE device when an operation start signal is received 0.2 seconds after the user has grasped the CE device will be described with reference to FIGS. 7A and 7B.

FIG. 7A illustrates an operation of a CE device according to the conventional art.

The user grasps the CE device at 0 seconds. According to the conventional art, since a booting operation is performed from the point of time when an operation start signal is received, no operation is performed at all when the user initially grasps the CE device.

An operation start signal is received 0.2 seconds after the user has grasped the CE device. According to the conventional art, only a normal booting mode corresponding to the second booting mode exists, and thus a booting operation is performed according to a normal booting mode.

The booting operation is completed 1 second after the user has grasped the CE device, and the user may use the CE device.

FIG. 7B illustrates an operation of a CE device in accordance with an exemplary embodiment.

When the user grasps the CE device, the CE device is booted according to a first booting mode. Consequently, a booting operation is performed from 0 seconds according to the first booting mode.

0.2 seconds after the user has grasped the CE device, an operation start signal is received. The booting operation according to the first booting mode is still being operated at the point of time when the operation start signal is received. Accordingly, a booting operation is performed according to the second booting mode subsequent to the currently processed booting operation 0.2 seconds after the user has grasped the CE device.

The booting operation is completed when 0.8 seconds has passed after the user has grasped the CE device, and the user may then use the CE device.

According to the conventional art, a booting operation is performed from a point of time when an operation start signal is received. Thus, no operation is performed at all until an operation start signal is received after the user has grasped the CE device.

On the other hand, according to the exemplary embodiment, the user performs a booting operation from the point of time when the user grasps the CE device, and thus the time required to boot the CE device and enter normal mode may be reduced.

An operation of an image reproducing apparatus in the case when external power is supplied and an operation start signal is received 0.6 seconds thereafter will be described with reference to FIGS. 7C and 7D.

FIG. 7C illustrates an operation of an image reproducing apparatus according to the conventional art.

At 0 seconds, the user grasps a CE device. No operation is performed at all at the point of time when the user grasps the CE device.

An operation start signal is received 0.6 seconds after external power is supplied. From the point of time when the operation start signal is received, a booting operation is performed according to a normal booting mode.

The booting operation is completed 0.8 seconds after the operation start signal is received, and the user may then use the CE device in normal mode.

FIG. 7D illustrates an operation of an image reproducing apparatus in accordance with an exemplary embodiment.

When the user grasps the CE device, the CE device is booted according to the first booting mode.

The booting operation according to the first booting mode is completed 0.5 seconds after the user has grasped the CE device. Since an operation start signal is not received until the booting operation according to the first booting mode is completed, the CE device operates in the sleep mode.

An operation start signal is received 0.6 seconds after the user grasps the CE device. A resuming operation is performed from the point of time when the operation start signal is received.

The resuming operation is completed 0.4 seconds after the resuming operation is performed, and then the user may use the CE device in normal mode.

The resuming operation according to the exemplary embodiment requires far less time than the booting operation according to the normal booting mode, and thus the user may use CE device as quickly as they want.

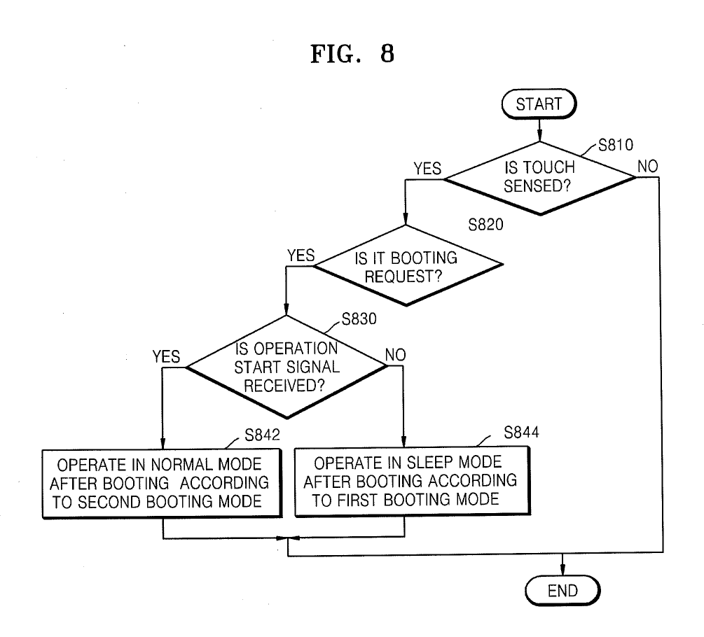

FIG. 8 is a flowchart illustrating a method of controlling a CE device in accordance with an exemplary embodiment.

In operation S810, a determination is made as to whether a touch by a user to a CE device is sensed. In order to sense the touch to the CE device, at least one sensor may be used. The type of the sensor may vary such as an electrostatic capacitive touch sensor, a decompression touch sensor, or a vibration sensor. When the touch to the CE device is sensed, the method proceeds to operation S820.

In operation S820, a determination is made as to whether the sensed touch is a booting request. When the sensed touch is determined to be a booting request, operation S830 is performed.

In operation S830, a booting operation according to a first booting mode is performed. Also, a determination is made as to whether an operation start signal is received before the booting operation according to the first booting mode is completed. When an operation start signal is received before the booting operation according to the first booting mode is completed, operation S842 is performed. If an operation start signal is not received until the second booting operation according to the first booting mode is completed, operation S844 is performed.

In operation S842, a booting operation according to a second booting mode is performed subsequent to the booting operation that has just been processed. When the booting operation according to the second booting mode is completed, the CE device is controlled to operate in a normal mode.

In operation S844, when the booting operation according to the first booting mode is completed, the CE device is controlled to operate in the sleep mode.

The embodiments of the present invention can be written as computer programs and can be implemented in general-use digital computers that execute the programs using a computer readable recording medium.

While not restricted thereto, the exemplary embodiments can also be embodied as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, the exemplary embodiments may be written as computer programs transmitted over a computer-readable transmission medium, such as a carrier wave, and received and implemented in general-use digital computers that execute the programs. Moreover, while not required in all aspects, one or more CE devices can include a processor or microprocessor executing a computer program stored in a computer-readable medium, such as a local storage device.

While the exemplary embodiments have been particularly shown and described, it will be understood by those of ordinary skill in the art that various changes in form and history may be made therein without departing from the spirit and scope of the present invention, as defined by the following claims. The embodiments should be considered in a descriptive sense only and not for purposes of limitation. Therefore, the scope of the present invention is defined not by the detailed description, but by the appended claims, and all differences within the scope will be construed as being included in the present invention.

What is claimed is:

1. A method of controlling a consumer electronics (CE) device, the method comprising:
sensing a touch to the CE device;
determining whether the touch corresponds to a booting request;
performing a booting operation when the touch is determined to correspond to a booting request; and
controlling the CE device to operate in the sleep mode when an operation start signal is not received until the booting operation is completed, and controlling the CE device to operate in a normal mode when an operation start signal is received before the booting operation is completed.

2. The method of claim 1, wherein the performing of the booting operation comprises performing a booting operation according to a first booting mode in which data is not output to outside of the CE device during the booting operation.

3. The method of claim 2, wherein the performing of the booting operation further comprises performing a booting operation according to a second booting mode in which data processed during the booting operation is output to outside of the CE device when the operation start signal is received before the booting operation according to the first booting mode is completed.

4. The method of claim 1, wherein the determining comprises determining whether the touch corresponds to a booting request, based on a location of a portion of the CE device where the touch is sensed.

5. The method of claim 1, further comprising setting a condition that the touch is determined as a booting request, based on touch position history information about a touch sensed at a previous point of time.

6. The method of claim 1, wherein the controlling comprises performing a resuming operation such that the CE device operates in the normal mode when the operation start signal is received while the CE device operates in the sleep mode.

7. The method of claim 1, wherein the controlling comprises controlling a power supply to at least one module included in the CE device according to an operational mode of the CE device.

8. The method of claim 7, wherein the controlling of the power supply comprises blocking the power supply to modules except for a control module which is to perform a resuming operation and a memory in which non-volatile data is stored while the CE device operates in the sleep mode.

9. The method of claim 1, wherein the controlling the CE device comprises controlling the CE device to operate in an end mode when the sleep mode continues for a critical length of time or longer.

10. A consumer electronics (CE) device comprising:
a touch sensing unit which senses a touch to the CE device;
a determining unit which determines whether the touch sensed by the touch sensing unit corresponds to a booting request;
a booting unit which performs a booting operation when the touch is determined to be a booting request; and
a control unit controlling the CE device to operate in a sleep mode when an operation start signal is not received until the booting operation is completed, and controlling the CE device to operate in a normal mode when the operation start signal is received before the booting operation is completed.

11. The CE device of claim 10, wherein the booting unit performs a booting operation according to a first booting mode in which data is not output to outside of the CE device during the booting operation.

12. The CE device of claim 11, further performing the booting operation according to a second booting mode in which data is output to outside of the CE device when the operation start signal is received before the booting operation according to the first booting mode is completed.

13. The CE device of claim 10, wherein the determining unit determines whether the touch corresponds to a booting request based on position information of the sensed touch.

14. The CE device of claim 10, wherein the determining unit sets a condition that the touch is determined as a booting request based on touch position history information about a touch sensed at a previous point of time.

15. The CE device of claim 10, wherein the control unit performs a resuming operation such that the CE device operates in a normal mode when the operation start signal is received while the CE device operates in the sleep mode.

16. The CE device of claim 10, wherein the control unit comprises a power control unit that controls a power supply to at least one module included in the CE device, according to an operational mode of the CE device.

17. The CE device of claim 16, wherein the power control unit blocks the power supply to modules, except for a control module which is to perform the resuming operation and a memory in which non-volatile data is stored, when the CE device operates in the sleep mode.

18. The CE device of claim 10, wherein the controlling comprises controlling the CE device to operate in an end mode when the sleep mode continues for a predetermined length of time or longer.

19. A computer readable recording medium having embodied thereon a program for executing a method of controlling a CE device, wherein a processor, when executing the program causes the program to execute the method comprising:
determining, when there is a touch to the CE device, whether the touch corresponds to a booting request;
performing a booting operation when the touch is determined to correspond to a booting request;
controlling the CE device to operate in a sleep mode when an operation start signal is not received until the booting operation is completed, and controlling the CE device to operate in a normal mode when an operation start signal is received before the booting operation is completed.
